(19) United States
(12) Patent Application Publication
(10) Pub. No.: US 2026/0260577 A1
(43) Pub. Date: Sep. 3, 2026

(54) ENGLISH WORD GENERATION AND READING PLATFORM

(71) Applicant: Ruyun Li, Beijing (CN)

(72) Inventor: Ruyun Li, Beijing (CN)

(21) Appl. No.: 18/994,626

(22) PCT Filed: Jul. 12, 2023
(86) PCT No.: PCT/CN2023/106976

§ 371 Date: Jan. 15, 2025

(30) Foreign Application Priority Data
Jul. 15, 2022 (CN) 202210832013.X

(51) Int. Cl. G09B 17/00; G10L 13/04

(52) U.S. Cl. CPC G09B 17/006; G10L 13/04

(57) ABSTRACT

An English word generation and reading platform includes a platform body and a constituting word carrier module and an electronic recognition and reading module that are installed on the platform body. The platform body is provided with a word generation and recognition area and a constituting word carrier storage area; the constituting word carrier module is divided into a main constituting word carrier and an auxiliary constituting word carrier. The electronic recognition and reading module is installed on the platform body, and includes a recognition unit, a control unit, and a vocalization unit which are in data connection.

### TECHNICAL FIELD

The present disclosure relates to the technical field of educational teaching tools, and in particular to an English word generation and reading platform.

### BACKGROUND ART

For learning to recognize, read and spell English words, there are currently four main methods as follows.

The first one is the phonics method, which includes firstly reading the pronunciation of each letter according to the pronunciation of the English letters in the word, and then trying to combine these pronunciations together to achieve the purpose of reading the pronunciation of the entire English word out. However, this method may be used for monosyllabic words, but is very problematic for polysyllabic words, because the pronunciation of each letter is still far from the final pronunciation of a word.

The second one is the whole language method, the core issue for which is that it hopes that children do not look at words from the perspective of letters, but read and remember a word as a whole. When a child is faced with an English reading book full of new words and does not understand how the letters are pronounced, it is still actually impossible to increase the amount of reading and solve the problem of reading obstacles.

The third one is the international phonetic system which is the most familiar to Chinese students. The international phonetic system is a set of symbols re-designed outside the English word pronunciation/phonetic system, and this set of symbols is used to mark the pronunciation of each word. The use of the international phonetic system requires seeing a word and looking up the phonetic symbols, which greatly increase the time it takes for children to learn English and secondly, also greatly increase the difficulty for Chinese children to learn English, if they cannot overcome the pronunciation barrier.

The fourth one is the Orthographic Cipher which has seven parts of knowledge and a seven-step voice processing process, including segmenting a word, finding the stressed syllable(s), determining the pronunciation of the stressed syllable(s), finding the weak syllable(s), determining the pronunciation of the weak syllable(s), and then trying to directly reading and spelling the word. In terms of the method, the biggest problems are that children cannot do without the teachers' teaching and the learning time is generally one semester, which is a long time. In addition, even if the children have learned the method, it still takes a long process of continuous practice and application for them to achieve the goal of being able to read words upon seeing and write words upon hearing. Without the follow-up supervision and guidance of teachers and parents, many children may gradually return to their original learning state.

Therefore, for the spelling, reading and pronunciation of unfamiliar words, a new set of training methods and training learning platforms are needed to train and learn the correct pronunciation of combination of multiple syllables, so as to pronounce encountered unfamiliar words accurately after the training is completed.

### SUMMARY

The purpose of the present disclosure is to provide an English word generation and reading platform, which distinguishes the syllables of a consonant-vowel structure and syllables of a consonant-consonant-vowel structure that constitute the words and sets a pronunciation rule, simplifies the learning method of word formation and pronunciation, and trains learners' pronunciation ability for polysyllabic unfamiliar words by randomly matching syllables and then pronouncing them.

In order to achieve the above purpose, the present disclosure is specifically implemented through the following technical solutions.

An English word generation and reading platform includes a platform body, and a constituting word carrier module and an electronic recognition and reading module which are installed on the platform body, where the platform body has a word generation and recognition area and a constituting word carrier storage area, the constituting word carrier module is provided with at least one constituting word display unit and at least one recognition tag, and one constituting word display unit is marked with one constituting word component;
the constituting word carrier module is divided into main constituting word carrier(s) and auxiliary constituting word carrier(s), the constituting word component marked on the constituting word display unit of the main constituting word carrier is a main constituting word component determined/judged by a word syllable stressing rule; the constituting word component marked on the constituting word display unit of the auxiliary constituting word carrier is an auxiliary constituting word component in an English word, collocated with the main constituting word component to form the word, and one main constituting word carrier and one auxiliary constituting word carrier may be placed in the word generation and recognition area to generate the English word; and
the electronic recognition and reading module is installed on the platform body, and includes a recognition unit, a control unit and a vocalization unit which are in data connection. The recognition unit is arranged in the word generation and recognition area, and sends recognition information to the control unit by recognizing the constituting word display unit of the constituting word carrier module placed in the word generation and recognition area; the control unit receives the recognition information and controls the vocalization unit to vocalize according to the pronunciation rule of the word and by a switch; and the vocalization unit reads out the pronunciation of the generated word according to the instruction of the control unit.

Further, the generated English words include real words and false words.

Further, the left side of the main constituting word component may also include an English word prefix.

Further, the constituting word carrier storage area includes a main constituting word carrier storage area and an auxiliary constituting word carrier storage area.

Further, the constituting word carrier module is of a long cubic structure, four sides of which are each provided with a constituting word display unit and a recognition tag corresponding to the recognition unit.

Further, the processing steps of the electronic recognition and reading module include: (1) recognizing the main constituting word component and the auxiliary constituting word component in the word generation and recognition area by reading the recognition tag of the constituting word carrier module; and (2) pronouncing the English word generated by the main constituting word component and the auxiliary constituting word component according to the pronunciation rule of words composed of short, long and common vowels.

Further, the pronunciation rule of words composed of short, long and common vowels are as follows: when only one vowel among the five vowels is collocated with the preceding consonant or consonant cluster (consonant-consonant) and when needing to judge whether the syllable is open or closed, the auxiliary constituting word component is an open syllable if starting with a consonant-vowel structure, and the vowel in the preceding syllable is pronounced as the letter name of the five vowels; and the auxiliary constituting word component is a closed syllable if starting with a consonant-consonant-vowel structure, and the vowel in the preceding syllable is pronounced as the letter sound of the five vowels; and the syllables with vowels in the auxiliary constituting word component are all pronounced according to the pronunciation rule of weak syllables.

On the English word generation and reading platform of the present disclosure, the learner may sequentially place in the word generation and recognition area the main constituting word carriers marked with consonant-vowel combinations and consonant-consonant-vowel combinations of any vowel family, and then take at least one auxiliary constituting word carrier carrying auxiliary constituting word syllable component according to the learner's learning progress and needs, make the main constituting word carriers collocated with auxiliary constituting word carriers in the generation and recognition area to generate a word, and make a recognizer read the pronunciation of the generated words. The generated English word may be pronounced only according to the pronunciation rule set on the electronic recognition and reading module of the present disclosure, without distinguishing real words and false words, and various pronunciations and spelling methods of English words may be trained centralizedly.

### BRIEF DESCRIPTION OF DRAWINGS

FIG. 1 is a schematic diagram of the overall structure of the present disclosure.

In the figure, 1—platform body; 11—word generation and recognition area; 12—constituting word carrier storage area; 121—main constituting word carrier storage area; 122—auxiliary constituting word carrier storage area; 2—constituting word carrier module; 21—constituting word display unit; 22—recognition tag; 23—main constituting word carrier; 24—auxiliary constituting word carrier; 3—electronic recognition and reading module; 31—recognition unit; 32—control unit; 33—vocalization unit.

### DETAILED DESCRIPTION OF EMBODIMENTS

The present disclosure is further described in detail below with reference to drawings and embodiments.

In the description of the present disclosure, it should be understood that unless otherwise expressly specified and limited, orientations and positional relationships indicated by the terms “up”, “down”, “front”, “back”, “left”, “right”, “top”, “bottom”, “inside”, “outside”, “center”, “vertical”, “horizontal”, etc. are orientations and positional relationships based on those shown in the drawings, only for facilitating describing the present disclosure and simplifying the description, rather than indicating or implying that the device or element referred to must have a specific orientation or be constructed and operated in a specific orientation, and therefore should not be understood as a limitation on the present disclosure.

The terms “install”, “link”, “connect”, “fix” and the like should be understood in a broad sense. For example, it may be fixed connection, detachable connection, or integral connection; it may be mechanical connection or electrical connection; it may be direct connection or indirect connection through an intermediate medium, or it may be the internal communication of two components. For those of ordinary skill in the art, the specific meanings of the above terms in the present disclosure may be understood according to specific situations.

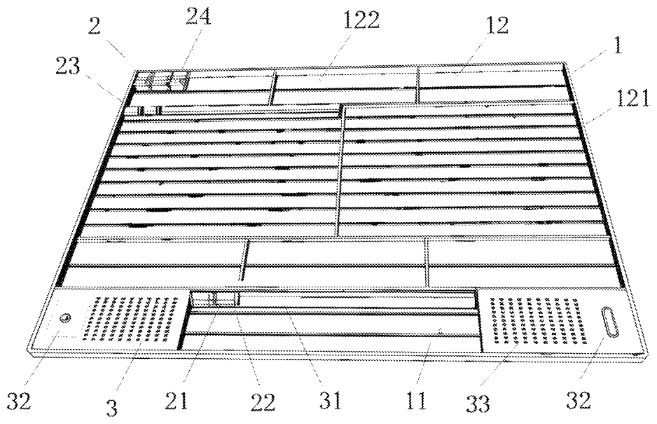

As shown in FIG. 1, an English word generation and reading platform of the present disclosure includes a platform body 1, and a constituting word carrier module 2 and an electronic recognition and reading module 3 which are installed on the platform body 1, and the platform body 1 has a word generation and recognition area 11 and a constituting word carrier storage area 12. At least one constituting word display unit 21 and a recognition tag 22 are set on the constituting word carrier module 2, and one constituting word display unit is marked with one constituting word component. The constituting word carrier module 2 is divided into a main constituting word carrier 23 and an auxiliary constituting word carrier 24. The constituting word component marked on the constituting word display unit 21 of the main constituting word carrier 23 is the main constituting word component determined by the word syllable stressing rule. Preferably, the left side of the main constituting word component may also include an English word prefix. The constituting word component marked on the constituting word display unit of the auxiliary constituting word carrier 24 is an auxiliary constituting word component in an English word, collocated with the main constituting word component to form the word.

The syllable of the consonant-vowel structure displayed by the constituting word display units 21 of the main constituting word carrier 23 and the auxiliary constituting word carrier 24 are pronounced as uninterrupted sounds, which are 468 syllables of consonant-vowel structure in total after combination of the existing 18 vowels and 26 consonants, such as ca, be, pea, etc. The consonant-consonant-vowel structures displayed by the constituting word display units 21 of the main constituting word carrier 23 and the auxiliary constituting word carrier 24 are more than 300 syllables of consonant-consonant-vowel structure of regular combinations in English words, such as sca, bla, gla, sta, shra, etc.

Accordingly, the constituting word carrier storage area 12 preferably includes a main constituting word carrier storage area 121 and an auxiliary constituting word carrier storage area 122. The main constituting word carrier storage area 121 is used to place a large number of main constituting word carriers 23, and the main constituting word carrier storage area 121 has multiple rows of partitions, which are divided into 18 vowel families according to the pronunciations of 18 vowels, placed in different partitions of the main constituting word carrier storage area 121; and the auxiliary constituting word carrier storage area 122 is used to place auxiliary constituting word carriers 24.

One main constituting word carrier 23 and one auxiliary constituting word carrier 24 may be placed in the word generation and recognition area 11 to generate one English word. To be further explained, the generated English words include real words and false words, that is, are not all limited to real words, but include false words, that is, meaningless words. Real words and false words have corresponding pronunciations according to the pronunciation rule of English. Two constituting word carrier modules 2 are placed in the word generation and recognition area 11, which are divided into the main constituting word carrier 23 on the left and the auxiliary constituting word carrier 24 on the right according to the stressing and weak reading rules. The syllable units on the constituting word display units 21 on the two constituting word carriers are ta and cky, respectively. After recognition, the electronic recognition and reading module 3 pronounces, in sequence, the main constituting word and the auxiliary constituting word, ta.cky.

The electronic recognition and reading module 3 is installed on the platform body 1, and includes a recognition unit 31, a control unit 32 and a vocalization unit 33 which are in data connection. The recognition unit 31 is arranged in the word generation and recognition area 11, and sends recognition information to the control unit by recognizing the constituting word display unit of the constituting word carrier module placed in the word generation and recognition area; the control unit receives the recognition information and controls the vocalization unit to vocalize according to the pronunciation rule of the word and by a switch; and the vocalization unit reads out the pronunciation of the generated word according to the instruction of the control unit.

Specifically, the processing steps of the electronic recognition and reading module include: (1) recognizing the main constituting word component(s) and auxiliary constituting word component(s) in the word generation and recognition area by reading the recognition tag of the constituting word carrier module; and (2) pronouncing the English word(s) generated by the main constituting word component(s) and auxiliary constituting word component(s), according to the pronunciation rule of words composed of short vowels, long vowels and ordinary vowels.

Specifically, the pronunciation rule of the words composed of short, long and common vowels includes: when only one vowel among the five vowels is collocated with the preceding consonant or consonant cluster and when needing to judge whether the syllable is open or closed, the auxiliary constituting word component is an open syllable if starting with a consonant-vowel structure, and the vowel in the preceding syllable is pronounced as the letter name of the five vowels; and the auxiliary constituting word component is a closed syllable if starting with a consonant-consonant-vowel structure, and the vowel in the preceding syllable is pronounced as the letter sound of the five vowels; and the syllables with vowels in the auxiliary constituting word component are all pronounced according to the pronunciation rule of weak syllables.

In one embodiment, the constituting word carrier module 1 is preferably of a cubic structure, the four sides of which are each provided with a constituting word display unit 21 and a recognition tag 22 corresponding to the recognition unit 31 of the electronic recognition and reading module 3. The constituting word carrier module 1 is embodied as a plurality of independent parts including main constituting word carrier(s) and auxiliary constituting word carrier(s), such that it is more flexible and convenient for learners to take them, use them repeatedly, and complete the activities of generating words and recognizing and reading words in any place they like. The word generation and recognition area 11 of the platform body 1 may be of a long groove shape, and three groups of long groove-shaped word generation and recognition areas 11 are arranged on one main body platform 1, and the recognition unit 31 of the electronic recognition and reading module 3 is arranged at the groove bottom of the word generation and recognition area 11. The constituting word carrier module 1 is in a shape of a long cube, where the four sides of the rectangular long cube are each provided with one constituting word display unit 21 and one recognition tag 22. The recognition tag 22 corresponding to the syllable unit of the constituting word display unit 21 is located on the opposite side of the long cube, that is, the recognition tag 22 of the constituting word display unit 21 displayed on the top surface is located on the bottom surface, facilitating recognition by the recognition unit 31. The recognition tag 22 of the constituting word display unit 21 and recognition positions of it and the recognition unit 31 may be changed for the convenience of recognition, which is a conventional change.

The technical solution of the present disclosure includes performing combination at the level of mature syllable pronunciation, and then conduct pronunciation listening and speaking training through the pronunciation rule, rather than combination between letters. The combination method of the present disclosure has more obvious practical application effect on the recognition and reading of English words, and the practical learning efficiency is higher.

The specific embodiments of the present disclosure are merely explanations of the present disclosure and are not intended to limit the present disclosure. After reading this specification, those skilled in the art may make modifications, as needed, to the embodiments without creative contributions, and they are protected by patent law as long as they are within the scope of the claims of the present disclosure.

1. An English word generation and reading platform, comprising a platform body, and a constituting word carrier module and an electronic recognition and reading module which are installed on the platform body, wherein the platform body is provided with a word generation and recognition area and a constituting word carrier storage area, the constituting word carrier module is provided with at least one constituting word display unit and at least one recognition tag, wherein one constituting word display unit is marked with one constituting word component;
the constituting word carrier module is divided into at least one main constituting word carrier and at least one auxiliary constituting word carrier, a constituting word component marked on a constituting word display unit of the at least one main constituting word carrier is a main constituting word component determined by a word syllable stressing rule; and a constituting word component marked on a constituting word display unit of the at least one auxiliary constituting word carrier is an auxiliary constituting word component in an English word collocated with the main constituting word component to form the word, wherein one main constituting word carrier and one auxiliary constituting word carrier can be placed in the word generation and recognition area to generate one English word; and
the electronic recognition and reading module is installed on the platform body, and comprises a recognition unit, a control unit and a vocalization unit which are in data connection, the recognition unit is arranged in the word generation and recognition area and configured to send recognition information to the control unit by recognizing the at least one constituting word display unit of the constituting word carrier module placed in the word generation and recognition area; the control unit is configured to receive the recognition information and control the vocalization unit to vocalize according to a word pronunciation rule and by a switch; and the vocalization unit is configured to read out pronunciation of the generated word according to an instruction of the control unit.

2. The English word generation and reading platform according to claim 1, wherein generated English words comprise real words and false words.

3. The English word generation and reading platform according to claim 1, wherein the main constituting word component and the auxiliary constituting word component both comprise syllables of a consonant-vowel structure or a consonant-consonant-vowel structure.

4. The English word generation and reading platform according to claim 1, wherein a left side of the main constituting word component further comprises an English word prefix.

5. The English word generation and reading platform according to claim 1, wherein the constituting word carrier storage area comprises a main constituting word carrier storage area and an auxiliary constituting word carrier storage area.

6. The English word generation and reading platform according to claim 1, wherein the constituting word carrier module is of a long cube structure, four sides of which are each provided with a constituting word display unit and a recognition tag corresponding to the recognition unit.

7. The English word generation and reading platform according to claim 1, wherein processing steps of the electronic recognition and reading module comprise: recognizing the main constituting word component and auxiliary constituting word component in the word generation and recognition area by reading the recognition tag of the constituting word carrier module; and pronouncing the English word generated by the main constituting word component and auxiliary constituting word component according to a pronunciation rule of words composed of short, long and common vowels.

8. The English word generation and reading platform according to claim 7, wherein the pronunciation rule of words composed of short, long and common vowels comprises that: when only one vowel among five vowels is collocated with a preceding consonant or consonant cluster and when needing to judge whether a syllable is open or closed, the auxiliary constituting word component is an open syllable if starting with a consonant-vowel structure, and a vowel in a previous syllable is pronounced as a letter name of the five vowels; and the auxiliary constituting word component is a closed syllable if starting with a consonant-consonant-vowel structure, and a vowel in the previous syllable is pronounced as a letter sound of the five vowels; and syllables with vowels in the auxiliary constituting word component are all pronounced according to a pronunciation rule of weak syllables.
